(19) United States
(12) Patent Application Publication
(10) Pub. No.: US 2021/0232686 A1
(43) Pub. Date: Jul. 29, 2021

(54) ATTACK DETECTION DEVICE, ATTACK DETECTION METHOD, AND ATTACK DETECTION PROGRAM

(71) Applicant: Mitsubishi Electric Corporation, Tokyo (JP)

(72) Inventors: Masashi TATEDOKO, Tokyo (JP); Tsuyoshi HIGUCHI, Tokyo (JP); Kiyoto KAWAUCHI, Tokyo (JP); Takeshi YONEDA, Tokyo (JP)

(73) Assignee: Mitsubishi Electric Corporation, Tokyo (JP)

(21) Appl. No.: 17/227,752

(22) Filed: Apr. 12, 2021

Related U.S. Application Data
(63) Continuation of application No. PCT/JP2018/042550, filed on Nov. 16, 2018.

(51) Int. Cl. G06F 21/56; G06N 20/00

(52) U.S. Cl. CPC G06F 21/566; G06F 2221/034; G06N 20/00

(57) ABSTRACT

Provided is an attack detection device including: an abnormality detection unit configured to detect, by acquiring an abnormality detection result which includes a facility ID, occurrence of an abnormality in a facility associated with the facility ID; a storage unit configured to store, as adjustment history data, data that associates the facility ID and an adjustment time; and an attack determination unit configured to determine that there is an attack on the facility associated with the facility ID, by obtaining an adjustment frequency of the facility from the adjustment history data which is stored in the storage unit, based on a result of detection by the abnormality detection unit, when the adjustment frequency exceeds an allowable number of times set in advance for the facility.

### CROSS REFERENCE TO RELATED APPLICATIONS

This application is a Continuation of PCT International Application No. PCT/JP2018/042550, filed on Nov. 16, 2018, of which is hereby expressly incorporated by reference into the present application.

### TECHNICAL FIELD

The present invention relates to an attack detection device, an attack detection method, and an attack detection program with which a cyberattack on a facility of, for example, a factory or a plant, is detected.

### BACKGROUND ART

There is a method of detecting an abnormality that occurs in a facility of, for example, a factory or a plant when a normal state or failure state of the facility is known, by comparing a past log and a current behavior and using a degree of deviation based on a result of the comparison (see Patent Literature 1 and Patent Literature 2, for example).

There is also a method of estimating a normal state of a facility by adaptation from a past log when the normal state of the facility cannot be defined in advance (see Patent Literature 3, for example).

Those methods of the related art are effective for detection of an abnormality that has occurred in a facility of, for example, a factory or a plant.

### CITATION LIST

### Patent Literature

[PTL 1] JP 6148316 B2

[PTL 2] JP 2018-073258 A

[PTL 3] JP H08-014955 A

### SUMMARY OF INVENTION

### Technical Problem

However, it is difficult with any of the methods of the related art described above to determine whether the detected abnormality is caused by a failure or deterioration of the facility itself or by a cyberattack from the outside.

The present invention has been made to solve the above-mentioned problem, and an object of the present invention is therefore to obtain an attack detection device, an attack detection method, and an attack detection program with which whether or not a cyberattack is a cause of a detected facility abnormality can be determined.

### Solution to Problem

According to one embodiment of the present invention, there is provided an attack detection device including: an abnormality detection unit configured to detect, by acquiring an abnormality detection result which includes a facility ID for identifying a facility, occurrence of an abnormality in a facility that is associated with the facility ID; and an attack determination unit configured to determine that there is an attack on the facility associated with the facility ID that is included in the abnormality detection result transmitted from the abnormality detection unit, by obtaining, based on the facility ID, an adjustment frequency of the facility associated with the facility ID from adjustment history data, when the adjustment frequency exceeds an allowable number of times set in advance for the facility, the adjustment history data associating the facility ID with an adjustment time at which an abnormality that has occurred in the facility is adjusted.

Further, according to one embodiment of the present invention, there is provided an attack detection method including: an abnormality detection step of detecting, by acquiring an abnormality detection result which includes a facility ID for identifying a facility, occurrence of an abnormality in a facility that is associated with the facility ID, and transmitting the abnormality detection result; and an attack determination step of determining that there is an attack on the facility associated with the facility ID that is included in the abnormality detection result transmitted in the abnormality detection step, by obtaining, based on the facility ID, an adjustment frequency of the facility associated with the facility ID from adjustment history data, when the adjustment frequency exceeds an allowable number of times set in advance for the facility, the adjustment history data associating the facility ID with an adjustment time at which an abnormality that has occurred in the facility is adjusted.

Further, according to one embodiment of the present invention, there is provided an attack detection program for causing a computer to execute: an abnormality detection step of detecting, by acquiring an abnormality detection result which includes a facility ID for identifying a facility, occurrence of an abnormality in a facility that is associated with the facility ID, and transmitting the abnormality detection result; and an attack determination step of determining that there is an attack on the facility associated with the facility ID that is included in the abnormality detection result transmitted in the abnormality detection step, by obtaining, based on the facility ID, an adjustment frequency of the facility associated with the facility ID from adjustment history data, when the adjustment frequency exceeds an allowable number of times set in advance for the facility, the adjustment history data associating the facility ID with an adjustment time at which an abnormality that has occurred in the facility is adjusted.

### Advantageous Effects of Invention

According to the attack detection device, the attack detection method, and the attack detection program of the present invention, whether or not the cyberattack is a cause of the detected facility abnormality can be determined.

### BRIEF DESCRIPTION OF DRAWINGS

FIG. 1 is a configuration diagram of a detection server according to a first embodiment of the present invention.

FIG. 2 is a diagram for illustrating a data configuration of adjustment history data to be stored in a storage unit in the first embodiment of the present invention.

FIG. 3 is a diagram for illustrating a configuration of connection between the detection server and an abnormality detection device according to the first embodiment of the present invention.

FIG. 4 is a diagram for illustrating an example of a hardware configuration that applies to each of the detection server and the abnormality detection device according to the first embodiment of the present invention.

FIG. 5 is a flow chart for illustrating a series of steps of attack detection processing to be executed in an attack detection device according to the first embodiment of the present invention.

FIG. 6 is a table for showing an example of information to be stored in the storage unit in the first embodiment of the present invention.

FIG. 7 is a diagram for showing adjustment history data in the form of a graph in the first embodiment of the present invention.

FIG. 8 is a configuration diagram of a detection server according to a second embodiment of the present invention.

FIG. 9 is a diagram for illustrating data configurations of adjustment history data and allowable range data to be stored in a storage unit in the second embodiment of the present invention.

FIG. 10 is a flow chart for illustrating a series of steps of attack detection processing to be executed in an attack detection device according to the second embodiment of the present invention.

FIG. 11 is a flow chart for illustrating a series of steps of learning processing to be executed about a window width and an allowable number of times in the attack detection device according to the second embodiment of the present invention.

### DESCRIPTION OF EMBODIMENTS

Description is now given of an attack detection device, an attack detection method, and an attack detection program according to preferred embodiments of the present invention with reference to the accompanying drawings. In the following embodiments, a detailed description is given of a technology with which a cyberattack can be detected by obtaining an adjustment frequency for each facility from a history of abnormalities detected for each facility in a certain fixed period, and determining whether or not the adjustment frequency exceeds an allowable number of times. In the following description, a cyberattack is simply referred to as “attack.”

### First Embodiment

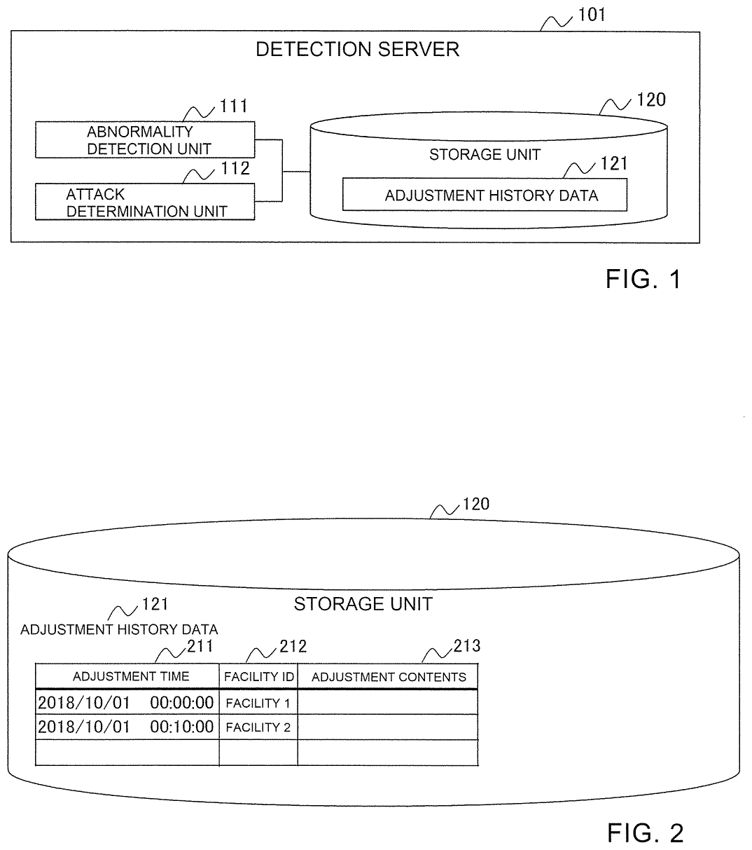

FIG. 1 is a configuration diagram of a detection server 101 according to a first embodiment of the present invention. The detection server 101 is an example of the attack detection device. The detection server 101 illustrated in FIG. 1 includes an abnormality detection unit 111, an attack determination unit 112, and a storage unit 120. The storage unit 120 stores adjustment history data 121.

FIG. 2 is an illustration of an example of a data configuration of the adjustment history data 121 to be stored in the storage unit 120 in the first embodiment of the present invention. As illustrated in FIG. 2, the adjustment history data 121 is configured so as to associate items that are an adjustment time 211, a facility ID 212, and adjustment contents 213 with one another. The adjustment history data 121 is not limited to the configuration of FIG. 2, and may have a configuration in which only two items that are the adjustment time 211 and the facility ID 212 are associated with each other.

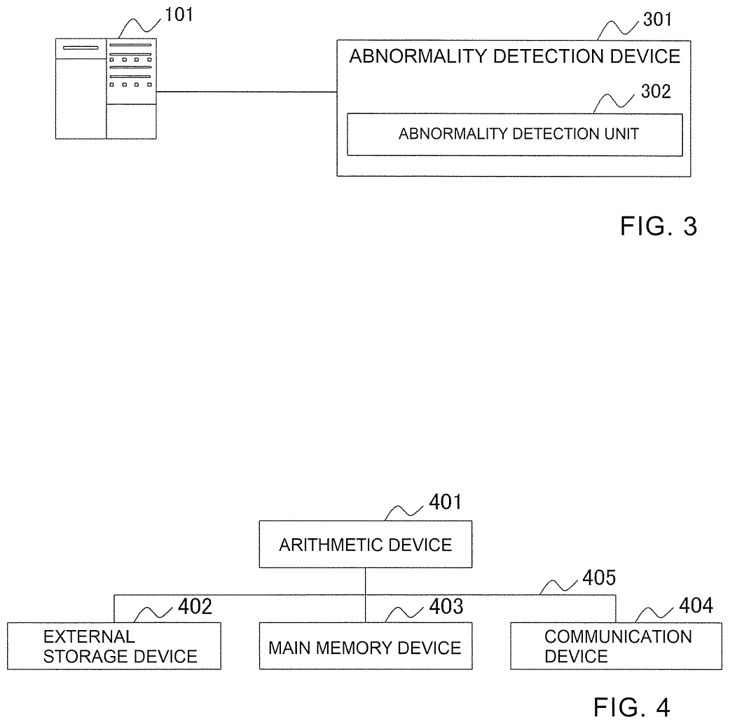

FIG. 3 is a diagram for illustrating a configuration of connection between the detection server 101 and an adjustment detection device 301 according to the first embodiment of the present invention. As illustrated in FIG. 3, the detection server 101 and the abnormality detection device 301 are connected by wired connection or wireless connection to hold communication to and from each other. The abnormality detection device 301 is installed at, for example, a factory, and has a function of detecting an abnormality that occurs in a facility inside the factory. The abnormality detection device 301 includes an abnormality detection unit 302 configured to detect an abnormality of a facility.

A configuration in which a plurality of abnormality detection devices 301 are connected to the detection server 101 may be employed. A plurality of abnormality detection devices 301 configured as a network having a plurality of layers may be connected to the detection server 101. The abnormality detection device 301 may be included inside the detection server 101.

The detection server 101 and the abnormality detection device 301 each include a computer including a central processing unit (CPU). Functions of the abnormality detection unit 111 and the attack determination unit 112 which are components of the detection server 101 are implemented by the CPU by executing a program. Similarly, a function of the abnormality detection unit 302 which is a component of the abnormality detection device 301 is implemented by the CPU by executing a program.

A program for executing processing of a component may be configured so as to be stored in a storage medium and read by the CPU out of the storage medium.

FIG. 4 is a diagram for illustrating an example of a hardware configuration that applies to each of the detection server 101 and the abnormality detection device 301 according to the first embodiment of the present invention. An arithmetic device 401, an external storage device 402, a main memory device 403, and a communication device 404 are connected to one another via a bus 405.

The arithmetic device 401 is a CPU configured to execute a program. The external storage device 402 is, for example, a read only memory (ROM) or a hard disk drive. The main memory device 403 is generally a random access memory (RAM). The communication device 404 is generally a communication card adapted for the Ethernet (trademark).

Programs are generally stored in the external storage device 402, and are sequentially read by the arithmetic device 401, and processing is executed under a state in which those programs are loaded onto the main memory device 403. The programs implement functions as the “abnormality detection unit 111” and “attack determination unit 112” illustrated in FIG. 1.

The storage unit 120 illustrated in FIG. 1 is implemented by, for example, the external storage device 402. The external storage device 402 also stores an operating system (hereinafter also referred to as “OS”), and at least part of the OS is loaded onto the main memory device 403. The arithmetic device 401 executes the OS and concurrently executes the programs that implement the functions of the “abnormality detection unit 111” and “attack determination unit 112” illustrated in FIG. 1.

Further, in the description of the first embodiment, each of information, data, a signal value, and a variable value indicating a result of the processing is stored in the main memory device 403 as a file.

The configuration of FIG. 4 is merely an example of a hardware configuration of each of the detection server 101 and the abnormality detection device 301. The hardware configuration of the detection server 101 and the abnormality detection device 301 is therefore not limited to the illustration of FIG. 4, and another configuration may be employed. For instance, a display or other output devices, or a mouse, a keyboard, or other input devices, may be connected to the bus 405.

The detection server 101 can implement information processing methods in the embodiments of the present invention through steps described in the embodiments with reference to flow charts.

Next, operations of the detection server 101 are described with reference to FIG. 1 to FIG. 3. Details of each of the operations are described later with reference to a flow chart.

The abnormality detection unit 111 acquires an abnormality detection result transmitted from the abnormality detection device 301. The abnormality detection result may be acquired by any methods as long as the contents acquired by the method include an abnormality detection time and a facility ID.

The attack determination unit 112 uses the adjustment history data 121 stored in the storage unit 120 to obtain an adjustment frequency in a time window set for each facility separately. The attack determination unit 112 further determines whether or not the adjustment frequency exceeds an allowable number of times set for each facility separately, to thereby detect that the facility has been attacked. The allowable number of times may be a threshold value set in advance, or may be set by adaptation from a past adjustment history. The method of determining the allowable number of times is not limited.

Next, data structure of the adjustment history data 121 that is used in the first embodiment is described with reference to FIG. 2. The adjustment history data of FIG. 2 is an example of a format used to store an adjustment history.

In FIG. 2, the adjustment time 211 is information for identifying a time of adjustment of an abnormality that has occurred in a facility associated with the facility ID. The adjustment time 211 may be data having any format as long as the data is recognizable as a date and a time.

The facility ID 212 is a unique identifier for identifying the facility at which the abnormality has occurred and has been adjusted.

The adjustment contents 213 are data indicating outline of the executed adjustment in a specific manner.

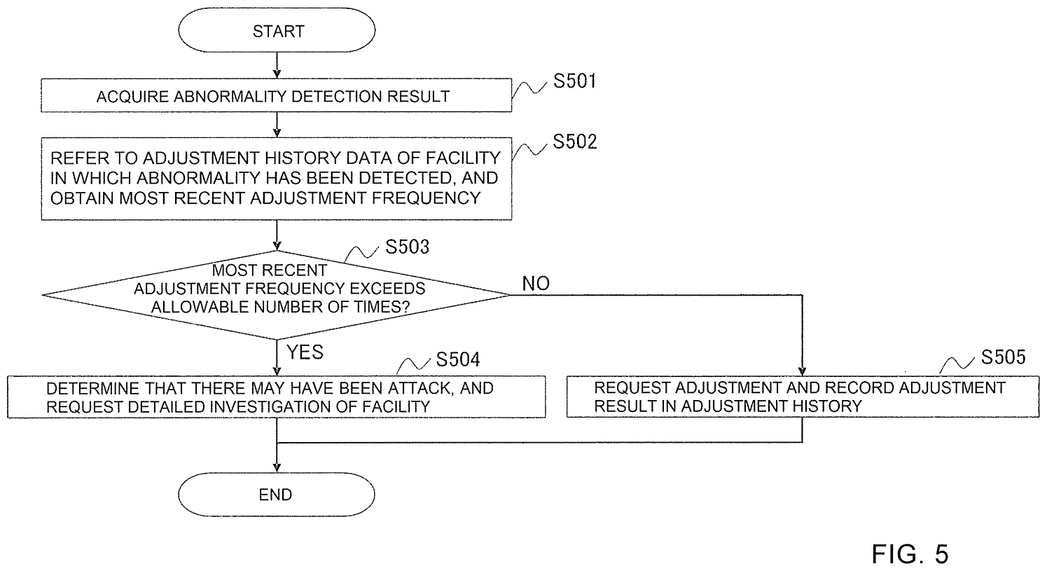

FIG. 5 is a flow chart for illustrating a series of steps of attack detection processing to be executed in the attack detection device according to the first embodiment of the present invention. The attack detection processing by the abnormality detection unit 111 and the attack determination unit 112 included in the detection server 101 is described below with reference to the flow chart illustrated in FIG. 5. Here, an abnormality that has occurred in a facility is assumed to be detected in advance by the abnormality detection device 301.

In Step S501, the abnormality detection unit 111 acquires an abnormality detection result about the abnormality detected by the abnormality detection device 301.

In Step S502, the attack determination unit 112 refers to the adjustment history data 121 based on the facility ID of a facility at which the abnormality has been detected in Step S501 to acquire the most recent adjustment frequency in a set time window.

In Step S503, the attack determination unit 112 compares the most recent adjustment frequency acquired in Step S502 with an allowable number of times of the adjustment frequency. The attack determination unit 112 proceeds to Step S504 when the most recent adjustment frequency acquired in Step S502 exceeds the allowable number of times, and proceeds to Step S505 when the acquired most recent adjustment frequency does not exceed the allowable number of times.

In the case of Step S504, the attack determination unit 112 determines that the facility at which the abnormality has been detected may have been attacked, and executes notification for requesting a detailed investigation of the facility. The method of requesting a detailed investigation may be notification to a person by displaying on a screen, automatic transmission of a message, or any other methods by which the start of a detailed investigation of the facility can be notified.

In the case of Step S505, on the other hand, the attack determination unit 112 executes notification for requesting adjustment that deals with the abnormality in a facility that has been detected in Step S501, and records an adjustment result including an adjustment time as the adjustment history data 121. The method of requesting the adjustment may be notification to a person by displaying a message requesting the adjustment on a screen, automatic transmission of a message requesting the adjustment, or any other methods by which the start of adjustment of the facility can be notified.

In both of the case of Step S504 and the case of Step S505, when the facility at which the abnormality has occurred is adjusted in response to the notification executed by the attack determination unit 112, the attack determination unit 112 acquires the time of execution of the adjustment as an adjustment time. The attack determination unit 112 also stores new data that associates the acquired adjustment time and the facility ID with each other in the storage unit 120, to thereby update the adjustment history data 121.

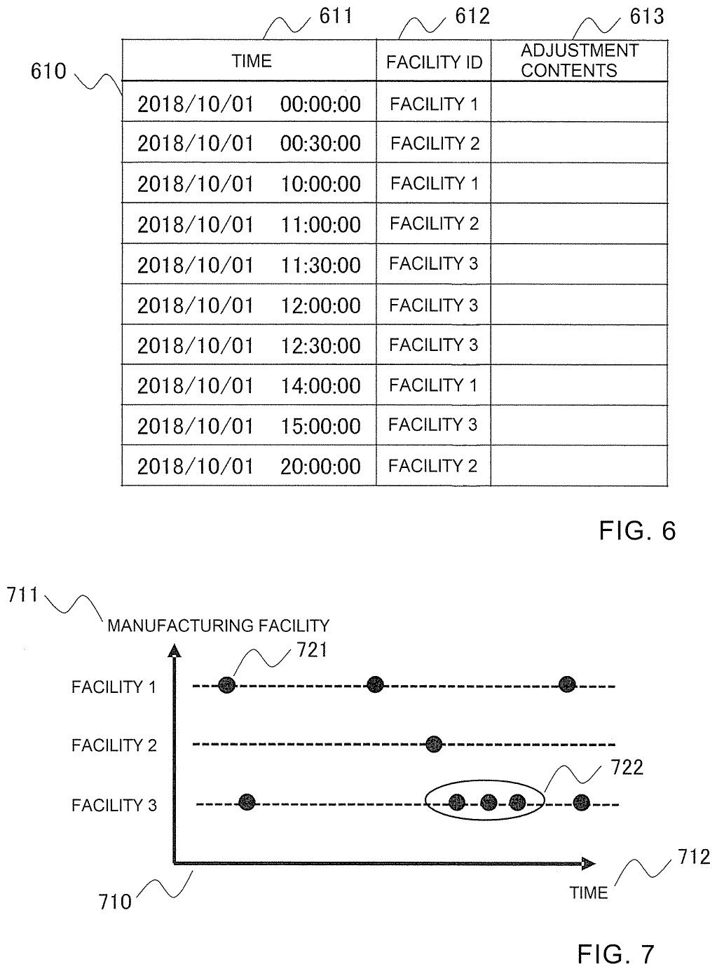

FIG. 6 is a diagram in which an example of the adjustment history data 121 to be stored in the storage unit 120 in the first embodiment of the present invention is illustrated as adjustment history data 610. A specific example of attack detection is described below with reference to FIG. 6.

First, the example of the adjustment history data 610 illustrated in FIG. 6 is described first. In FIG. 6, ten adjustment history entries are already stored as the adjustment history data 610. The contents of each row of the adjustment history data 610 include a time 611, a facility ID 612, and adjustment contents 613.

FIG. 7 is a diagram for showing the adjustment history data 610 in the form of a graph 710 in the first embodiment of the present invention. Adjustment frequency is described with reference to the graph 710. A vertical axis 711 of the graph 710 indicates the type of a manufacturing facility and corresponds to the facility ID 612. A horizontal axis 712 of the graph 710 indicates the elapsed time and corresponds to the time 611. The time 611 and the facility ID 612 which are included in each row of the adjustment history data 610 correspond to one of dots 721 shown on the graph 710.

The attack determination unit 112 identifies a section 722 in which entries of adjustment appear often on the graph 710 shown in FIG. 7. When the adjustment frequency in the section 722 in which entries of adjustment appear often exceeds an allowable number of times, the attack determination unit 112 determines that the facility may have been attacked. The allowable number of times may be a common value irrespective of the facility ID 612, or a value that is different for each facility ID 612.

The attack determination unit 112 of the attack detection device according to the first embodiment of the present invention thus starts attack detection processing with the abnormality detection result acquired by the abnormality detection unit 111 as a starting point. The attack determination unit 112 then uses the adjustment history data 121 stored in the storage unit 120 to obtain an adjustment frequency in a set time window for the section in which entries of adjustment appear often. The attack determination unit 112 compares the obtained adjustment frequency and the allowable number of times, to thereby determine whether or not the facility may have been attacked. That is, the attack determination unit 112 can determine whether or not there has been a cyberattack based on the frequency of detection of a facility abnormality.

The methods of the related art are limited to detection of an abnormality that is a state different from a known normal state. The use of the attack detection processing executed by the attack detection device according to the first embodiment provides an advantageous effect in that whether or not an attack is a cause of the detected abnormality is detectable.

### Second Embodiment

In a second embodiment of the present invention, description is given of a case in which an attack detection device learns a window width and an allowable number of times, and the window width and the allowable number of times that are updated with the result of the learning are used to implement a detection server capable of detecting an attack by adaptation.

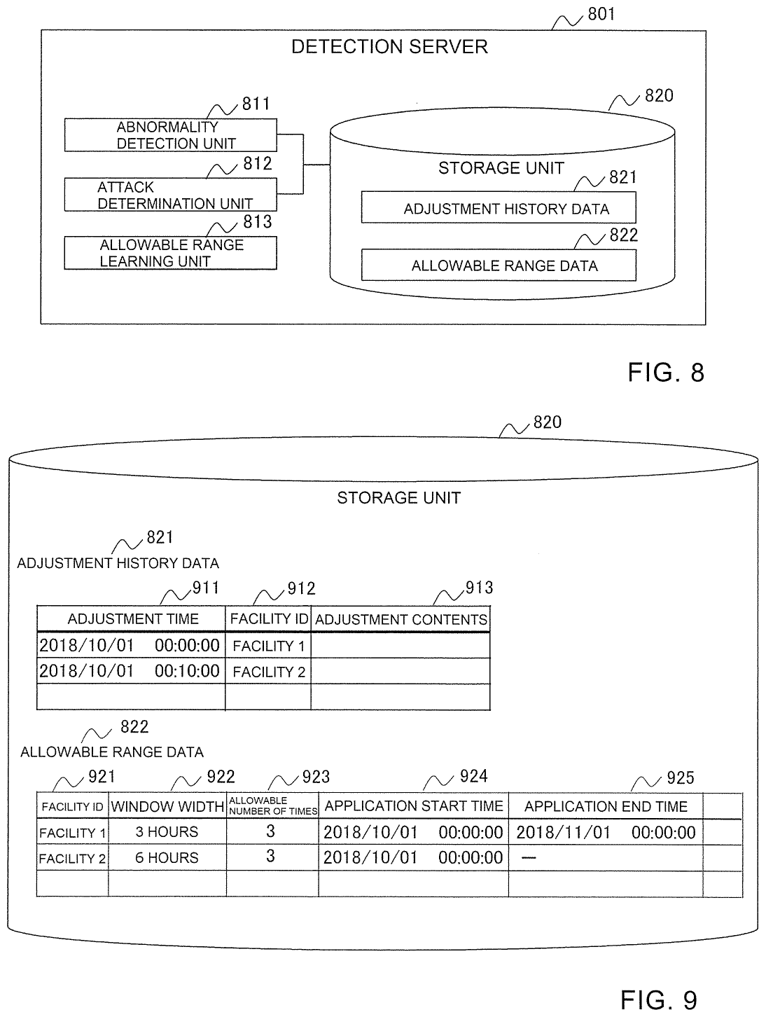

FIG. 8 is a configuration diagram of a detection server 801 according to the second embodiment of the present invention. The detection server 801 is an example of the attack detection device. The detection server 801 illustrated in FIG. includes an abnormality detection unit 811, an attack determination unit 812, an allowable range learning unit 813 serving as a learning unit, and a storage unit 820. The detection server 801 of FIG. 8 is configured by adding the allowable range learning unit 813 and allowable range data 822 inside the storage unit 820 to the detection server 101 according to the preceding first embodiment. The following description focuses on those newly added components.

FIG. 9 is a diagram for illustrating data configurations of adjustment history data 821 and the allowable range data 822 which are to be stored in the storage unit 820 in the second embodiment of the present invention. The adjustment history data 821 includes an adjustment time 911, a facility ID 912, and adjustment contents 913, and has the same configuration as that of the adjustment history data 121 in the preceding first embodiment. Description of the adjustment history data 821 is therefore omitted. As illustrated in FIG. 9, the allowable range data 822 is configured so as to associate items that are a facility ID 921, a window width 922, an allowable number of times 923, an application start time 924, and an application end time 925 with one another.

Operations of a learning function by the detection server 801 are described below with reference to FIG. 8. Details of the operations are described later with reference to a flow chart. The operation of the abnormality detection unit 811 and the operation of the attack determination unit 812 are the same as those of the abnormality detection unit 111 and the attack determination unit 112 which are described in the preceding first embodiment, and descriptions thereof are accordingly omitted.

The allowable range learning unit 813 is configured to feed the result of investigation by a person or a machine on an attack determination result provided by the attack determination unit 812 back to the allowable range data 822. The feedback to the allowable range data 822 may be reflected after the investigation, or may be reflected regularly.

Next, data structure used in the second embodiment is described with reference to FIG. 9. The adjustment history data 821 of FIG. 9 is the same as the adjustment history data 121 described in the first embodiment, and description thereof is accordingly omitted.

The allowable range data 822 of FIG. 9 is an example of a format used to store an allowable range.

The facility ID 921 is a unique identifier for identifying a facility at which adjustment has been executed.

The window width 922 is a window width corresponding to a time window that is used to count a frequency in an adjustment history in attack determination.

The allowable number of times 923 corresponds to an upper-limit allowable value of the frequency in the adjustment history within the window width 922.

The application start time 924 is a time at which application of the window width 922 and the allowable number of times 923 to the facility ID 921 is started. The application start time 924 may be stored as data having any format as long as the data is recognizable as a date and a time.

The application end time 925 is a time at which application of the window width 922 and the allowable number of times 923 to the facility ID 921 is ended. Setting of the application end time 925 is omitted when a cutoff point of the application is not clear, to thereby include all times subsequent to the application start time 924 as a target for learning. The application end time 925 may be data having any format as long as the data is recognizable as a date and a time and the case in which the cutoff point is unclear is discernible.

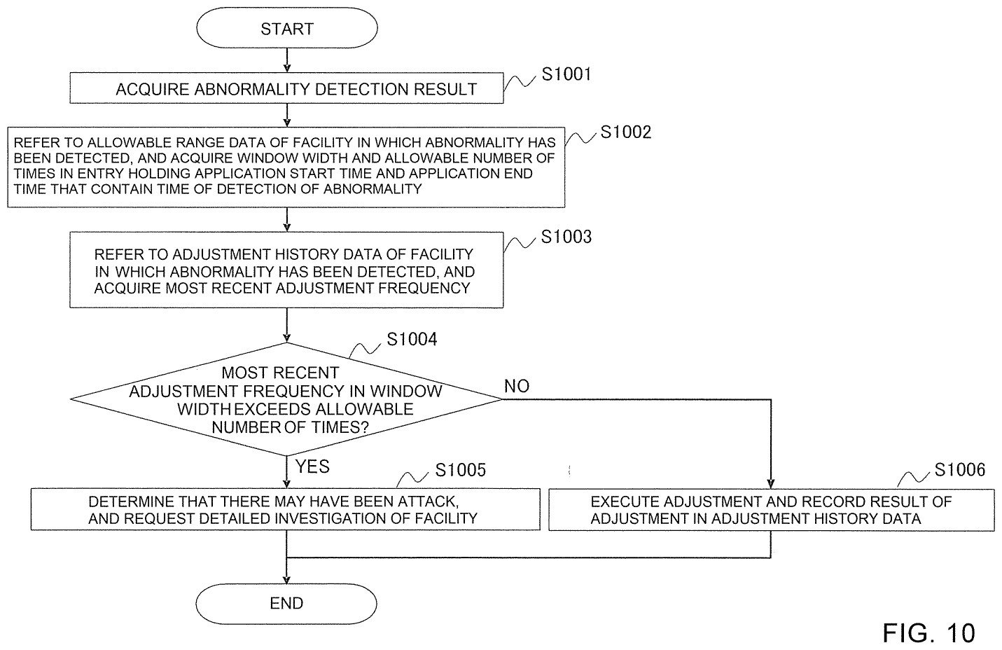

FIG. 10 is a flow chart for illustrating a series of steps of attack detection processing to be executed in the attack detection device according to the second embodiment of the present invention. The attack detection processing by the abnormality detection unit 811 and the attack determination unit 812 included in the detection server 801 is described below with reference to the flow chart illustrated in FIG. 10. Here, an abnormality that has occurred in a facility is assumed to be detected in advance by the abnormality detection device 301.

The flow chart illustrated in FIG. 10 is the flow chart described in the preceding first embodiment with reference to FIG. 5 to which determination processing using a learned allowable number of times is added.

In Step S1001, the abnormality detection unit 811 acquires an abnormality detection result about the abnormality detected by the abnormality detection device 301.

In Step S1002, the attack determination unit 812 refers to the allowable range data 822 based on a facility ID of a facility at which the abnormality has been detected in Step S1001, to acquire a window width and an allowable number of times in a row in which the time of detection of the abnormality is after the operation start time and before the application end time, or the time of detection of the abnormality is after the application start time and the application end time is blank.

In Step S1003, the attack determination unit 812 refers to the adjustment history data 821 based on the facility ID of the facility at which the abnormality has been detected in Step S1001, to acquire the most recent adjustment frequency. The attack determination unit 812 uses the window width acquired in Step S1002 to count the most recent adjustment frequency of the facility that is within a time window indicated by the acquired window width. Specifically, when the window width is hours, the attack determination unit 812 counts, as the adjustment frequency, the number of times adjustment has been executed in the last 3 hours.

In Step S1004, the attack determination unit 812 compares the allowable number of times acquired in Step S1002 with the most recent adjustment frequency acquired in Step S1003. The attack determination unit 812 proceeds to Step S1005 when the most recent adjustment frequency exceeds the allowable number of times, and proceeds to Step S1006 when the acquired most recent adjustment frequency does not exceed the allowable number of times.

In the case of Step S1005, the attack determination unit 812 determines that the facility at which the abnormality has been detected may have been attacked, and executes notification for requesting a detailed investigation of the facility. The method of requesting a detailed investigation may be notification to a person by displaying on a screen, automatic transmission of a message, or any other methods by which the start of a detailed investigation of the facility can be notified.

In the case of Step S1006, on the other hand, the attack determination unit 812 executes notification for requesting adjustment that deals with the abnormality in a facility that has been detected in Step S1001, and records an adjustment result as the adjustment history data 821. The method of requesting the adjustment may be notification to a person by displaying a message requesting the adjustment on a screen, automatic transmission of a message requesting the adjustment, or any other methods by which the start of adjustment of the facility can be notified.

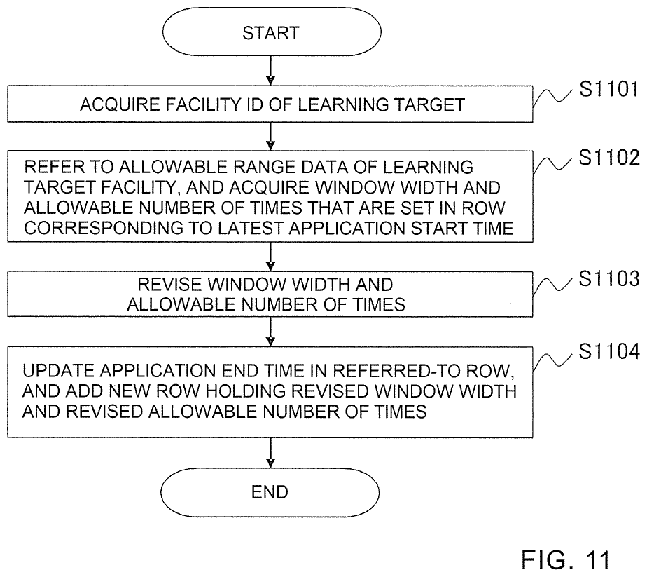

FIG. 11 is a flow chart for illustrating a series of steps of learning processing to be executed about a window width and an allowable number of times in the attack detection device according to the second embodiment of the present invention.

In Step S1101, the allowable range learning unit 813 acquires a facility ID of a manufacturing facility that is a target of learning. The allowable range learning unit 813 may acquire the facility ID by manual input, reflection of a result of a machine-executed investigation, or any other methods as long as the facility ID acquired by the method is recognizable.

In Step S1102, the allowable range learning unit 813 refers to the allowable range data 822 based on the facility ID acquired in Step S1101, to acquire a window width and an allowable number of times that are set in a row holding the latest application start time.

In Step S1103, the allowable range learning unit 813 learns the window width and the allowable number of times that have been acquired in Step S1102 and revises the window width and the allowable number of times based on the result of determination by the attack determination unit 812. Examples of a specific method of revising the window width and the allowable number of times include: a method in which the window width and the allowable number of times are set small in an initial period of installation of a new facility and are then changed based on an actual adjustment frequency; a method in which the window width and the allowable number of times are changed based on an actual adjustment frequency when the type of a product manufactured changes significantly; and a method in which the allowable number of times is increased based on the tendency of deterioration of the facility. The allowable range learning unit 813 may revise the window width and the allowable number of times by a statistical method based on a past history, a method using machine learning, or any other methods as long as the window width and the allowable number of times are quantifiable by the method.

In Step S1104, the allowable range learning unit 813 updates the application end time in the row referred to in Step S1102 with a time to start application of the window width and the allowable number of times that have been revised in Step S1103. The allowable range learning unit 813 also adds a new row to the allowable range data 822 by setting that time as an application start time and using the window width and the allowable number of times that have been revised in Step S1103.

In the newly added row, the application end time is “blank,” and the facility ID is the facility ID acquired in Step S1101. A new row in which the window width and the allowable number of times have been revised can be added for a facility that is a learning target by executing this series of steps of processing.

In the second embodiment, the detection server 801 thus causes the allowable range learning unit 813 to learn the allowable range data 822 stored in the storage unit 120 based on actual behavior of facilities, to thereby update the allowable range data 822 for each facility sequentially with an appropriate window width and an appropriate allowable number of times. As a result, the precision of attack determination is raised even higher.

This provides, in addition to the effect obtained in the first embodiment, an additional effect in that an attack can be detected with high precision even in such cases as when the type of a product manufactured changes significantly and when the adjustment frequency gradually changes due to deterioration.

In the first embodiment described above, the detection server 101 includes the storage unit 120. However, the configuration is not limited thereto and the storage unit 120 may be provided outside the detection server 101 as a component of an external device, instead of a component of the detection server 101. In an example of a configuration for that case, the storage unit 120 is provided in an external device that is a server or the like installed outside the detection server 101. The detection server 101 acquires, from this external device, the adjustment history data 121 accumulated in the storage unit 120 of the external device, to determine whether or not a facility has been attacked. The same applies to the storage unit 820 of the detection server 801 of the second embodiment. That is, the storage unit 820 may be provided outside the detection server 801 as a component of an external device instead of a component of the detection server 801. In that case, the detection server 801 and the storage unit 820 may have, for example, the same configurations as those of the detection server 101 and the storage unit 120, and descriptions thereof are accordingly omitted here.

### REFERENCE SIGNS LIST

101 detection server (attack detection device), 111 abnormality detection unit, 112 attack determination unit, 120 storage unit, 121 adjustment history data, 301 abnormality detection device, 302 abnormality detection unit, 401 arithmetic device, 402 external storage device, 403 main memory device, 404 communication device, 405 bus, 801 detection server (attack detection device), 811 abnormality detection unit, 812 attack determination unit, 813 allowable range learning unit (learning unit), 820 storage unit, 821 adjustment history data, 822 allowable range data

1. An attack detection device, comprising:
abnormality detection circuitry configured to detect, by acquiring an abnormality detection result which includes a facility ID for identifying a facility, occurrence of an abnormality in a facility that is associated with the facility ID; and
attack determination circuitry configured to determine that there is an attack on the facility associated with the facility ID that is included in the abnormality detection result transmitted from the abnormality detection circuitry, by obtaining, based on the facility ID, an adjustment frequency of the facility associated with the facility ID from adjustment history data, when the adjustment frequency exceeds an allowable number of times set in advance for the facility, the adjustment history data associating the facility ID with an adjustment time at which an abnormality that has occurred in the facility is adjusted.

2. The attack detection device according to claim 1, further comprising a memory configured to store the adjustment history data.

3. The attack detection device according to claim 1, wherein the attack determination circuitry is configured to:
identify the facility that is associated with the facility ID included in the abnormality detection result, by acquiring the abnormality detection result from the abnormality detection circuitry, and notify that adjustment is required for the identified facility;
acquire, as the adjustment time, a time at which the facility in which the abnormality has occurred is adjusted in response to the notification; and
update the adjustment history data by storing, in the memory, new data that associates the facility ID and the adjustment time with each other.

4. The attack detection device according to claim 2, wherein the attack determination circuitry is configured to:
identify the facility that is associated with the facility ID included in the abnormality detection result, by acquiring the abnormality detection result from the abnormality detection circuitry, and notify that adjustment is required for the identified facility;
acquire, as the adjustment time, a time at which the facility in which the abnormality has occurred is adjusted in response to the notification; and
update the adjustment history data by storing, in the memory, new data that associates the facility ID and the adjustment time with each other.

5. The attack detection device according to claim 1,
wherein the memory is configured to further store allowable range data which includes a time window for obtaining the adjustment frequency for each facility ID, and the allowable number of times, and
wherein the attack determination circuitry is configured to determine that there is an attack on the facility when an adjustment frequency within the time window is obtained and the obtained adjustment frequency exceeds the allowable number of times.

6. The attack detection device according to claim 2,
wherein the memory is configured to further store allowable range data which includes a time window for obtaining the adjustment frequency for each facility ID, and the allowable number of times, and
wherein the attack determination circuitry is configured to determine that there is an attack on the facility when an adjustment frequency within the time window is obtained and the obtained adjustment frequency exceeds the allowable number of times.

7. The attack detection device according to claim 3,
wherein the memory is configured to further store allowable range data which includes a time window for obtaining the adjustment frequency for each facility ID, and the allowable number of times, and
wherein the attack determination circuitry is configured to determine that there is an attack on the facility when an adjustment frequency within the time window is obtained and the obtained adjustment frequency exceeds the allowable number of times.

8. The attack detection device according to claim 4,
wherein the memory is configured to further store allowable range data which includes a time window for obtaining the adjustment frequency for each facility ID, and the allowable number of times, and
wherein the attack determination circuitry is configured to determine that there is an attack on the facility when an adjustment frequency within the time window is obtained and the obtained adjustment frequency exceeds the allowable number of times.

9. The attack detection device according to claim 5, further comprising a learning circuitry configured to learn the time window and the allowable number of times that are stored in the memory in association with the facility ID, based on a history of results of determination by the attack determination circuitry, and update the allowable range data based on a result of the learning.

10. The attack detection device according to claim 6, further comprising a learning circuitry configured to learn the time window and the allowable number of times that are stored in the memory in association with the facility ID, based on a history of results of determination by the attack determination circuitry, and update the allowable range data based on a result of the learning.

11. The attack detection device according to claim 7, further comprising a learning circuitry configured to learn the time window and the allowable number of times that are stored in the memory in association with the facility ID, based on a history of results of determination by the attack determination circuitry, and update the allowable range data based on a result of the learning.

12. The attack detection device according to claim 8, further comprising a learning circuitry configured to learn the time window and the allowable number of times that are stored in the memory in association with the facility ID, based on a history of results of determination by the attack determination circuitry, and update the allowable range data based on a result of the learning.

13. An attack detection method, comprising:
detecting, by acquiring an abnormality detection result which includes a facility ID for identifying a facility, occurrence of an abnormality in a facility that is associated with the facility ID, and transmitting the abnormality detection result; and
determining that there is an attack on the facility associated with the facility ID that is included in the abnormality detection result transmitted in the detecting the occurrence of the abnormality, by obtaining, based on the facility ID, an adjustment frequency of the facility associated with the facility ID from adjustment history data when the adjustment frequency exceeds an allowable number of times set in advance for the facility, the adjustment history data associating the facility ID with an adjustment time at which an abnormality that has occurred in the facility is adjusted.

14. An attack detection program for causing a computer to execute:
detecting, by acquiring an abnormality detection result which includes a facility ID for identifying a facility, occurrence of an abnormality in a facility that is associated with the facility ID, and transmitting the abnormality detection result; and
determining that there is an attack on the facility associated with the facility ID that is included in the abnormality detection result transmitted in the detecting the occurrence of the abnormality, by obtaining, based on the facility ID, an adjustment frequency of the facility associated with the facility ID from adjustment history data, when the adjustment frequency exceeds an allowable number of times set in advance for the facility, the adjustment history data associating the facility ID with an adjustment time at which an abnormality that has occurred in the facility is adjusted.
